(19) United States
(12) Patent Application Publication
(10) Pub. No.: US 2007/0176937 A1
(43) Pub. Date: Aug. 2, 2007

(54) Document processing operation system

(75) Inventors: Minoru Koshimizu, Kanagawa (JP); Yoshitsugu Hirose, Kanagawa (JP); Masao Watanabe, Kanagawa (JP); Naoki Hayashi, Kanagawa (JP); Hiroyuki Funo, Kanagawa (JP); Hiroyuki Hotta, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/500,914

(22) Filed: Aug. 9, 2006

(30) Foreign Application Priority Data
Jan. 27, 2006 (JP) 2006-018852

(51) Int. Cl. G06T 1/60

(52) U.S. Cl. 345/530

(57) ABSTRACT

A document processing operation system includes: an image display holding medium that includes a display section for holding display of a document image rewritably and in a substantially no-power supply state; and a processing unit that processes document data in response to operation information of a user for the medium, wherein the medium further includes: an operation device that accepts operation input from a user; and an information providing section that provides operation information entered on the operation device to the processing unit, wherein the processing unit includes: a data processing section that performs processing preset in response to the operation information for data of a document whose display is held on the medium; a holding section that holds the operation information acquired from the medium; and a start command section that causes the data processing section to start processing in response to the held operation information.

### BACKGROUND

1. Technical Field

This invention relates to an art of using an image display holding medium for holding display of a document image in a substantially no-power supply state on a display section and a document processing operation art of performing processing relating to document data in response to user operation input to the image display holding medium selectively or by trial and error.

2. Related Art

A document is created, edited, read, etc., by performing data processing using a computer.

To read such an electronic data document, generally a document image is displayed on a display screen of a computer or a document image is printed on paper of a paper medium using a printer.

In recent years, paper-like flexible thin electronic paper capable of holding display of a document image rewritably and in a no-power supply state has been developed as a document read medium that can replace paper.

Unlike paper, such electronic paper enables erasion or overwrite of the document image whose display is held on the display section and can be used repeatedly and therefore it is also desirable to promote the user of the electronic paper from the viewpoint of paper resource savings, etc.

### SUMMARY

According to an aspect of the invention, there is provided a document processing operation system including: an

image display holding medium that includes a display section for holding display of a document image rewritably and in a substantially no-power supply state; and a processing unit that processes document data in response to operation information of a user for the image display holding medium, wherein the image display holding medium further includes: an operation device that accepts operation input from a user; and an information providing section that provides operation information entered on the operation device to the processing unit, wherein the processing unit includes: a data processing section that performs processing preset in response to the operation information for data of a document whose display is held on the image display holding medium; a holding section that holds the operation information acquired from the image display holding medium; and a start command section that causes the data processing section to start processing in response to the held operation information.

### BRIEF DESCRIPTION OF THE DRAWINGS

Exemplary embodiment(s) of the present invention will be described in detail based on the following figures, wherein:

FIG. 1 is a drawing to describe the configuration of a document processing operation system according to one exemplary embodiment of the invention;

FIG. 2A to 2D are schematic representations of a classification and command table according to the exemplary embodiment of the invention;

FIG. 3 is a drawing to show electronic paper according to the exemplary embodiment of the invention;

FIGS. 4A and 4B are drawings to show specific examples of display images according to the exemplary embodiment of the invention;

FIG. 5 is a drawing to show the determination result according to the exemplary embodiment of the invention;

FIG. 6 is a drawing to describe a use method of optical write type electronic paper;

FIG. 7 is a drawing to describe the operation principle of optical write type electronic paper;

FIG. 8 is a drawing to describe the structure of optical write type electronic paper; and

FIG. 9 is a drawing to describe the operation principle of self-write type electronic paper;

FIG. 10 is a drawing to describe the structure of self-write type electronic paper;

FIG. 11 is a drawing to describe the configuration of a processing unit according to another exemplary embodiment of the invention;

FIG. 12 is a drawing to describe the configuration of a processing unit according to still another exemplary embodiment of the invention; and

FIGS. 13A and 13B are drawings to show the structure relating to one example of a passive sensor.

### DETAILED DESCRIPTION

The invention will be discussed specifically based on exemplary embodiments.

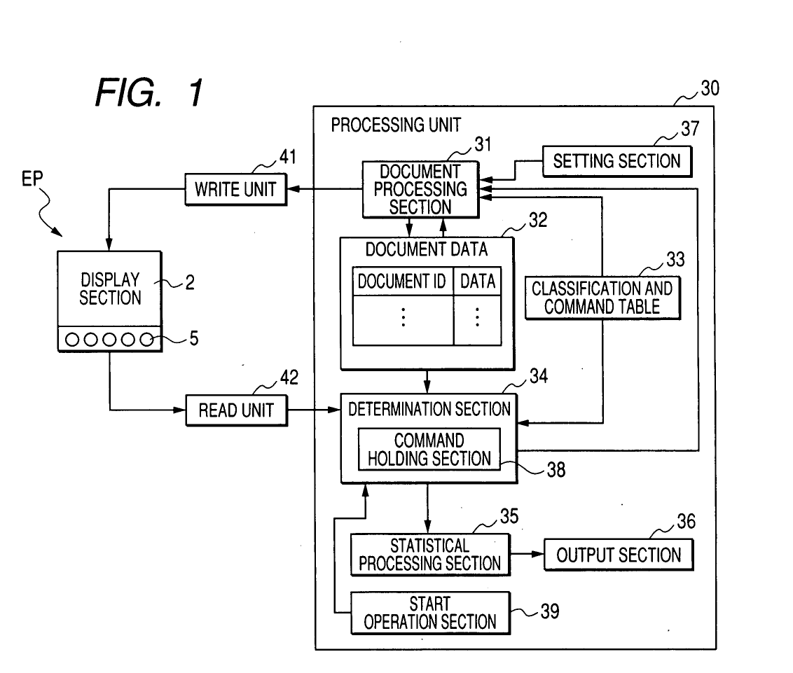

FIG. 1 shows the configuration of a document processing operation system according to one exemplary embodiment of the invention.

In the exemplary embodiment, electronic paper is used as an image display holding medium, but any other unit having a function of holding display of a document image rewritably and in a substantially no-power supply state, a plurality of operation devices for accepting operation input from the user, and an information providing section for providing a processing unit with operation information indicating which operation device operation input is executed for can also be used.

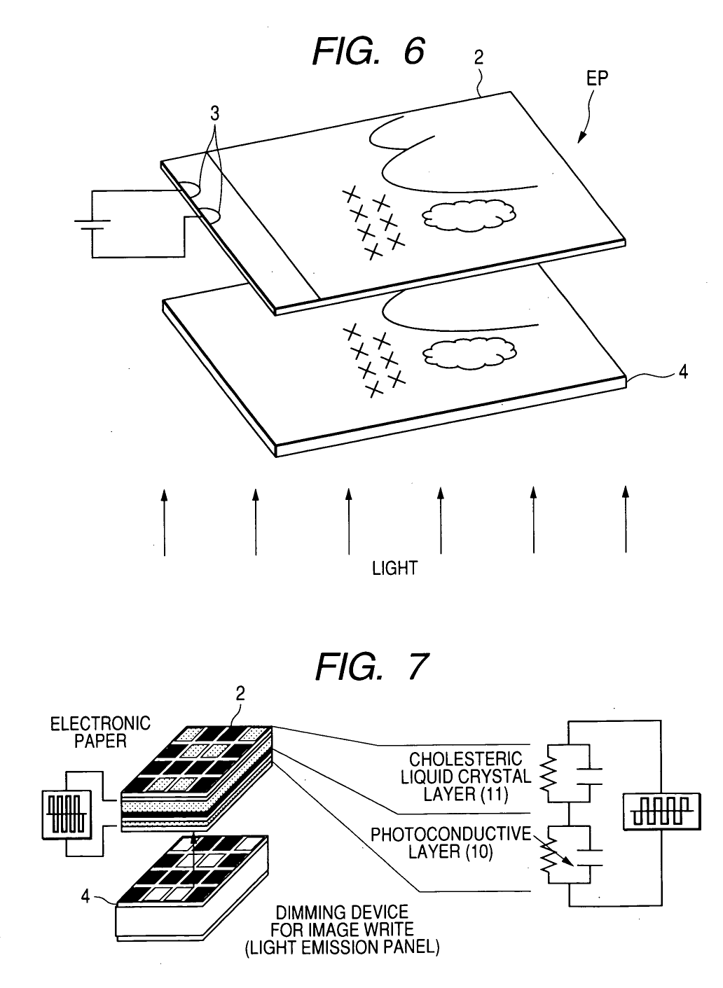

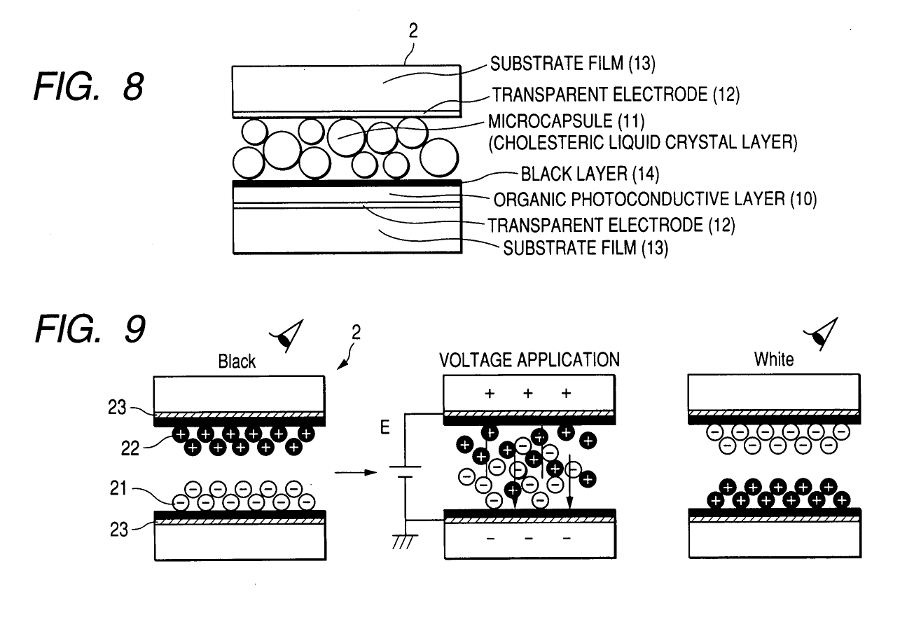

To begin with, the basic configuration and function of electronic paper EP will be discussed specifically with reference to examples shown in FIGS. 6 to 10.

FIG. 6 shows optical write type electronic paper EP. The electronic paper EP shown in the figure has a display section 2 for holding display of a display image and electrodes 3 for applying a write voltage to the display section 2.

The optical write type electronic paper EP is a flexible thin medium of a size like A4-size paper, for example, and has the display section 2 occupying the most area for holding display of a display image containing a document image and an choise image in a substantially no-power supply state. Here, “no-power supply state” may not be completely “0”, as long as the image cannot be actively rewritten.

For example, as shown in the figure, an image is displayed as information on a liquid crystal panel 4 and while a voltage from an external power supply is applied to the electrode 3, optical write type electronic paper EP is put on the liquid crystal panel 4 and light is applied, whereby the information image displayed on the liquid crystal panel 4 can be transferred to the display section 2 for storage. In short, the optical write type electronic paper EP has a function of transferring the projected image information to the display section 2 as voltage is applied to the electrode 3 and continuing to hold the image information in a display state still after the voltage applied to the electrode 3 is removed.

To use the optical write type electronic paper EP, a write unit 41 described later has a function of applying write voltage to the electrode 3 of the electronic paper EP set in the write unit and projecting a display image onto the display section 2.

The optical write type electronic paper EP has a structure wherein a layer of organic photoconductive material (organic photoconductive layer) 10 used with a copier and a layer of liquid crystal display material (cholesteric liquid crystal layer put into microcapsules) 11 are used in combination and these layers are sandwiched between a pair of surface and back transparent electrodes 12 and the layered body is sandwiched between a pair of surface and back transparent substrate films 13, as shown in FIG. 11 representing the cross-sectional structure of the display section 2. In the structure, monochrome image display can be produced with white display provided by the cholesteric liquid crystal layer 11 reflecting light and black display as light passes through the liquid crystal layer 11 and is absorbed in a black layer 14 provided between the cholesteric liquid crystal layer 11 and the organic photoconductive layer 10. Further, since the cholesteric liquid crystal has a characteristic of interference reflecting of color light responsive to helical pitches, the cholesteric liquid crystal layer 11 is formed by depositing liquid crystal materials different in helical pitch, so that it is also possible to realize color display as a simple structure.

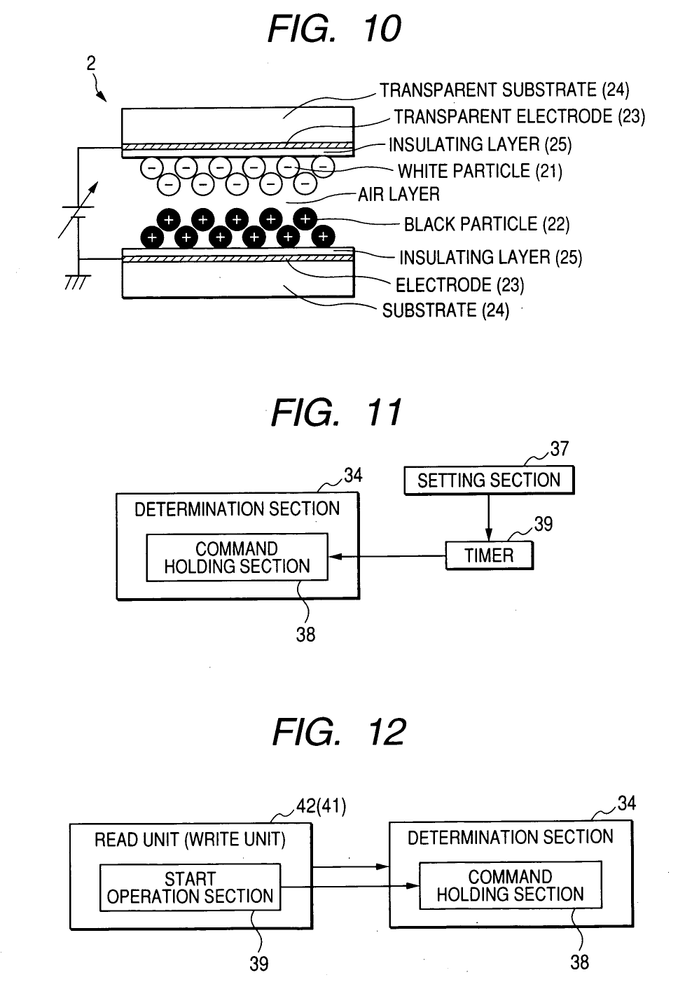

For example, an image to be transferred to the dimming device panel for image write (light emission panel) 4 is displayed on the optical write type electronic paper EP and is projected on the display section 2 and when a voltage is applied to the electrode 3, intensity of light is converted into the reflection density in a moment and the projection image is retained, as shown in FIG. 10 representing the operation principle of the display section 2. An erasion voltage is applied to the electrode 3, whereby the image information retained in the display section 2 can be erased and the optical write type electronic paper EP can be used repeatedly as write and erasion are repeated. Without performing such erasion processing for the optical write type electronic paper EP, a voltage is applied to the electrode 3 and a new image is projected as described above, whereby the image information retained in the display section 2 can also be overwritten with new information; the optical write type electronic paper EP can be used repeatedly as such overwrite processing is performed.

Therefore, the electric write type electronic paper EP has the nature of holding the image information transferred by projecting an image in a substantially no-power supply state as well as the thin and flexible nature like paper and thus is an image display holding medium that can be used as if it were paper used with a printer and a copier and moreover can be reused repeatedly.

Self-write type electronic paper EP is a flexible thin image display holding medium of a size like A4-size paper, for example, like the optical write type electronic paper EP and is provided with a processing function of writing an image to a display section 2 in response to data in addition to the display section 2 occupying the most area.

The processing function includes a driver for driving the display section 2, a wireless section for conducting wireless communications with the write unit described later, memory for retaining electronic data in a readable and writable manner, a control section (CPU) for performing predetermined processing, and a battery for supplying operation power to the function section of the control section, etc.

The display section 2 and the processing function section may be made detachable and, for example, clip-type processing function section may be attached to the display section 2 for connection, thereby forming electronic paper EP.

Such self-write type electronic paper EP can conduct wireless communications with an external write unit by the wireless section, thereby receiving electronic data of a display image and retaining electronic data of a plurality of pages in the memory.

The self-write type electronic paper EP can drive the driver under the control of the control section for rewrite display of a display image on the display section 2 based on the electronic data retained in the memory and has a function of continuing to hold the image in a display state on the display section 2 if the drive power of the driver is removed.

To use the self-write type electronic paper EP, the write unit 41 described later has a function of transmitting display image data to the electronic paper EP in a communication zone.

The self-write type electronic paper EP has a structure wherein fine colored particles used as toner with a copier (in the example shown in the figure, white particles 21 and black particles 22) are filled between a pair of surface and back electrodes 23 with at least the surface being transparent and they are sandwiched between a pair of surface and back film substrates 24 with at least the surface being transparent, as shown in FIG. 10 representing the cross-sectional structure of the display section 2. An air layer is provided between the electrode layers 23 so as to allow the colored particles 21 and 22 to move freely, and each matrix-like electrode layer 23 is provided with an insulating layer 25 for preventing the electrode layer from coming in contact with the colored particles 21 and 22. Using a color filter, color display can also be realized as a simple structure.

In the self-write type electronic paper EP, the negatively (minus) charged white particles 21 remain on the back and the positively (plus) charged black particles 22 remain on the surface in a state in which no voltage is applied to the electrode 23 (however, the electrode 23 is charged in the polarity at the previous drive time) and if the user visually observes the display section 2 from the surface, the display section 2 is placed in a black state, as shown in FIG. 9 representing the operation principle of the display section 2. When the driver operates based on the image data and the electrode polarity of the required part of the matrix responsive to the information image to be displayed is inverted, the positional relationship between the white particles 31 and the black particles 22 is replaced and image information based on the contrast between the white particles 21 and the black particles 22 is displayed on the display section 2. The driver is operated based on different image data, whereby the image information displayed on the display section 2 based on the contrast between the white particles 21 and the black particles 22 can be switched and the electronic paper EP can be reused repeatedly.

Therefore, the self-write type electronic paper EP has the nature of holding the image information displayed on the display section 2 in a substantially no-power supply state as well as the thin and flexible nature like paper and thus is an image display holding medium that can be used as if it were paper.

The document processing operation system using the electronic paper EP as described above as image display holding media includes electronic paper EP and a processing unit 30, and the processing unit 30 has the write unit 41 and a read unit 42 as separate units connected to the processing unit 30, as shown in FIG. 1.

The write unit 41 has a function responsive to the type of electronic paper EP as described above (optical write type or self-write type) and writes a display image generated in the processing unit 30 to electronic paper EP to hold-display of the image on the display section 2.

In the exemplary embodiment, the electronic paper EP is provided with passive sensors 5 similar to RFID of an ID tag, etc., each as a combination of an operation device and an information providing section to accept user operation as described later. The read unit 42 has a function of supplying operation power as a radio wave to one range as with RFID, starting each passive sensor 5 existing in the range, and wirelessly reading the state retained by the passive sensor 5 for transmission (operation information). That is, the read unit 42 has a function of a reader of ID tags, etc.

The processing unit 30 has a document processing section 31 for performing image generation processing and document data processing, a document database 32 for retaining and managing document data in association with document IDs, a classification and command table 33 for managing choice information, a determination section 34 for referencing the classification and command table 33 and determining which choice has been selected out of operation information, a statistical processing section 35 for performing statistical processing based on the determined operation information (choice), an output section 36 for outputting the statistical processing result as screen display, etc., and a setting section 37 for accepting various settings such as setting of choice information added to a document image from the operator.

The processing unit 30 further has a command holding section 38 for holding operation information input from electronic paper EP and putting output of the operation information to the determination section 34 on hold and a start operation section 39 for outputting the operation information held in the command holding section 38 to the determination section 34 in response to operator (or user) operation. The operator enters a start command, whereby the determination section 34 determines operation information and instructs the document processing section 31 and the statistical processing section 35 to start data processing responsive to the determination result, as described later.

In the exemplary embodiment, a computer as the processing unit 30 (in the exemplary embodiment, containing the write unit 41 and the read unit 42) is caused to execute a program according to the invention, thereby implementing the document processing section (image generation section) 31 for generating a display image into which choice information placed at the positions corresponding to the passive sensors 5 and a document image are combined, the write unit (write section) 41 for writing the generated display image to an image display holding medium to hold display of the image on the display section 2, the read unit (read section) 42 for wirelessly reading the operation information retained in each passive sensor 5, the document processing section 31, the determination section 34, and the statistical processing section 35 (data processing section) for performing processing relating to document data preset in response to the read operation information, the command holding section 38, and the start operation section 39.

The document processing section 31 not only performs processing of acquiring setup choice information from the classification and command table 33, acquiring setup document data from the document database 32, and generating a display image into which choice information placed at the positions corresponding to the passive sensors 5 provided on the electronic paper EP and a document image are combined, but also generates a display image turning a document page and generates a blank image to erase the image on the display section 2 in response to the determination result of the determination section 34. Further, the document processing section 31 performs document data processing of deleting the data of the document displayed on the display section 2 from the document database 32, transmitting document data to a predetermined address by electronic mail or facsimile, etc., in response to the determination result of the determination section 34.

The statistical processing section 35 performs statistical processing of totalizing choice answers, etc., in response to the determination result of the determination section 34. That is, the document processing section 31 and the statistical processing section 35 make up data processing section for performing processing relating to document data preset in the classification and command table 33.

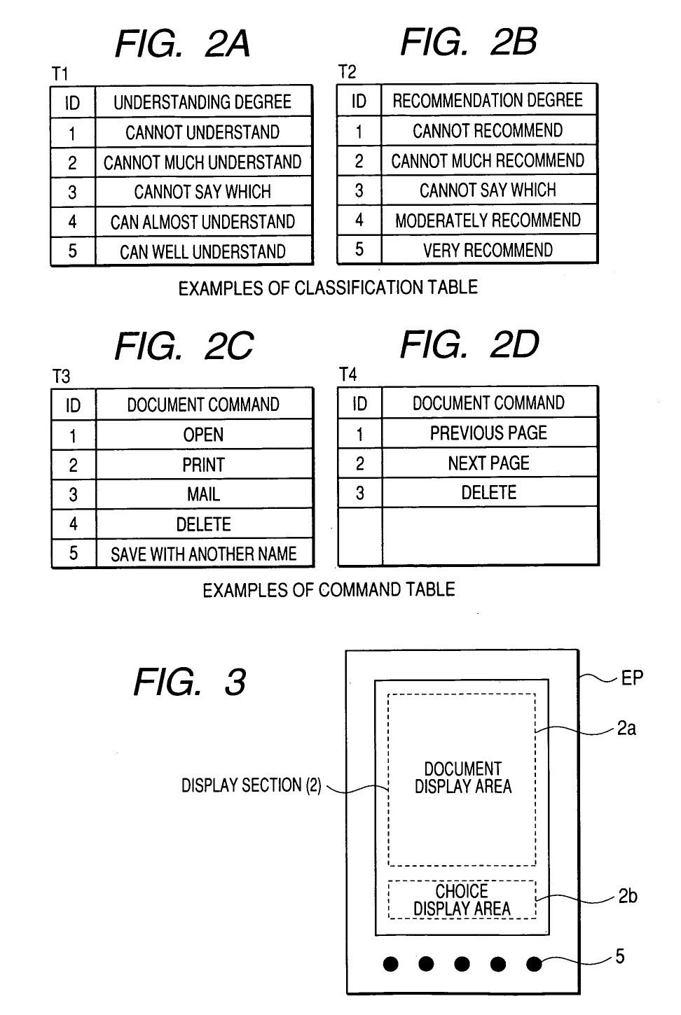

FIG. 2A to 2D illustrate the classification and command table 33; in the exemplary embodiment, four tables of T1 to T4 are provided as shown in FIG. 2A to 2D.

In each table, the operation description (understanding degree, recommendation degree, document command) is associated with the ID (choice number) indicating operation information. For example, understanding degree “cannot understand” is associated with operation information ID 1 in the table T1; recommendation degree “cannot say which” is associated with operation information ID 3 in the table T2; “save with another name” document data as a document command is associated with operation information ID 5 in the table T3; and “next page” for turning a page for updating the document image on the display section 2 as a document command is associated with operation information ID 2 in the table T4.

FIG. 3 is a front view of the electronic paper EP; in the exemplary embodiment, five passive sensors are placed below the display section 2.

The display section 2 is provided with a choice display area 2b for displaying choice information relating to the understanding degree, the recommendation degree, and the document commands shown in FIG. 2A to 2D below a document display area 2a for displaying a document image of a questionnaire, etc.

The passive sensor 5 is a device of a combination of a button-like operation device and RFID memory for retaining operation information as the polarity s inverted by operation in one. Power is supplied only to the RFID memory with the polarity inverted (namely, the user presses the button) by a radio wave emitted by the read unit 42 for starting the RFID memory (passive sensor), and operation information is read by the read unit 42. The sensor ID is previously stored in each passive sensor 5 and is also read by the read unit 42 together with the operation information and which sensor 5 with the polarity state changed (which choice in response to the sensor placement) is can be determined.

The invention is not limited to the configuration as in the exemplary embodiment and may adopt a configuration wherein if the user viewing the document image whose display is held on the display section operates an operation button provided on electronic paper EP, a wireless section provided in the electronic paper EP immediately transmits the operation information of operating the operation button to the processing unit 30 and the operation information is held in the command holding section 38.

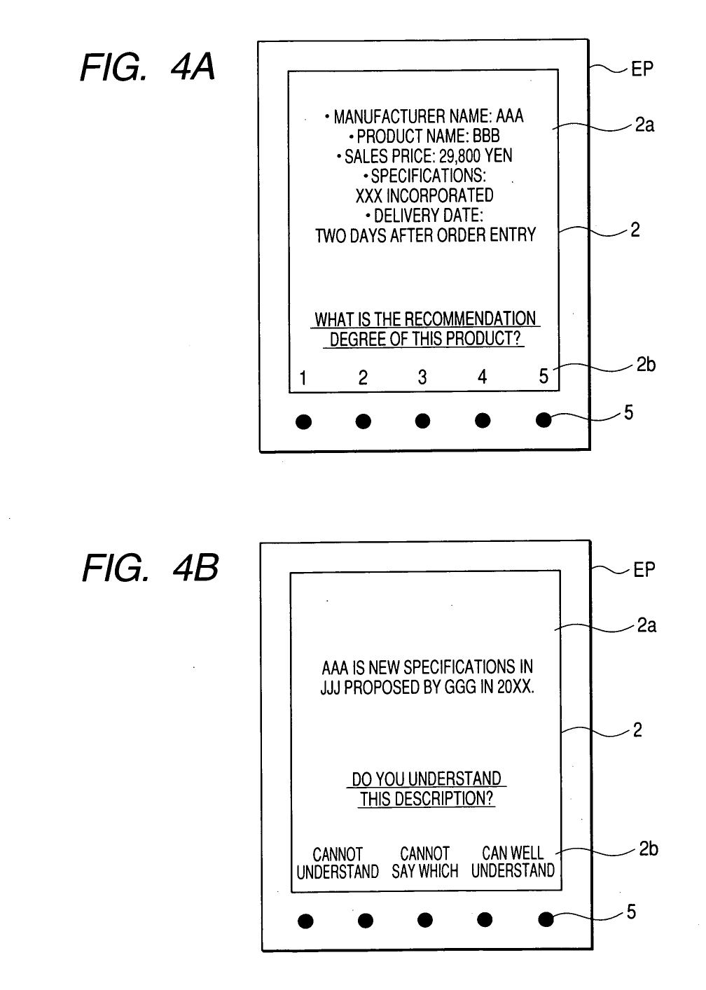

FIGS. 4A and 4B show each a specific example of holding display of a display image into which a document image and choice information are combined on the display section 2.

FIG. 4A shows an example of electronic paper EP distributed to the user for a questionnaire survey on a product, wherein a questionnaire document and choice information of the recommendation degree of the product (1 to 5) are displayed on the display section 2 and the five recommendation degree choices (1 to 5) are displayed corresponding to the positions of the five passive sensors 5.

FIG. 4B shows an example of electronic paper EP distributed to the user for a questionnaire survey on technical description, wherein a technical description document and choice information of the understanding degree of the description (cannot understand, cannot say which, can well understand) are displayed on the display section 2 and the three understanding degree choices are displayed corresponding to the three alternate positions of the five passive sensors 5.

Similar comments also apply to choice information of document commands of mail transmission of document data, page turning of document image, etc., and document command description information or corresponding ID numbers as well as a document image are displayed corresponding to the positions of the five passive sensors 5.

Next, the processing operation of the document processing operation system of the exemplary embodiment will be discussed.

When the operator selects the document to be written to electronic paper EP and classification or command choice information (any one of T1 to T4) through the setting section 37 and enters a write command to electronic paper EP, the document processing section 31 reads the selected document data from the document database 32 and also reads the choice information (or choice ID) of the selected table and generates a display image into which a document image and choice information placed at the positions corresponding to the passive sensors 5 are combined based on the document data and the choice information. The document processing section 31 inputs the generated display image to the write unit 41, which then performs write processing of the display image to the display section 2 of the electronic paper EP in response to the type of electronic paper.

In the write processing, the document ID for identifying the document written to the electronic paper EP and the table ID (any of T1 to T4) are input to the determination section 34 and are used for the later determination processing.

If different types of documents are distributed and selection operation information is collected from the users although not required if only one type of document is distributed and selection operation information is collected from the users, to identify the collected documents, the electronic paper EP may be provided with writable RFID, for example, and the document ID of the document written to the RFID may be written and later may be read by the read unit 42 and may be input to the determination section 34.

In the exemplary embodiment, the electronic paper EP is provided with RFID retaining the display medium ID for identifying the electronic paper and when a display image is written to the electronic paper EP, the read unit 42 wirelessly reads the display medium ID from the RDIF and inputs the display medium ID to the determination section 34, thereby enabling the determination section 34 to keep track of the correspondence among the display medium ID of the electronic paper EP, the document ID of the document written to the electronic paper, and the choice information table ID.

The user views the document image displayed on the display section 2 of the electronic paper EP distributed and selects any of the displayed choices by pressing the passive sensor 5 corresponding to the selected choice. That is, the user selects the choice as an answer to the displayed document or a processing command to be executed for the displayed document by pressing the corresponding passive sensor 5.

If the electronic paper EP subjected to user's selection operation is positioned in the proximity of the read unit 42, the read unit 42 wirelessly reads and detects the polarity state change (operation information) and the sensor ID of the sensor 5 together with the display medium ID and inputs them to the command holding section 38.

When a processing start command is input from the start operation section 39, a start trigger is input to the command holding section 38 and the determination section 34 starts determination processing based on the operation information held in the command holding section 38.

The determination section 34 determines the document ID and the table ID based on the display medium ID and determines which choice the user selects based on the sensor ID and the operation information and instructs the document processing section 31 to perform processing or the statistical processing section 35 to perform statistical processing in response to the operation information of user's selection operation in response to the determination result of the determination section 34.

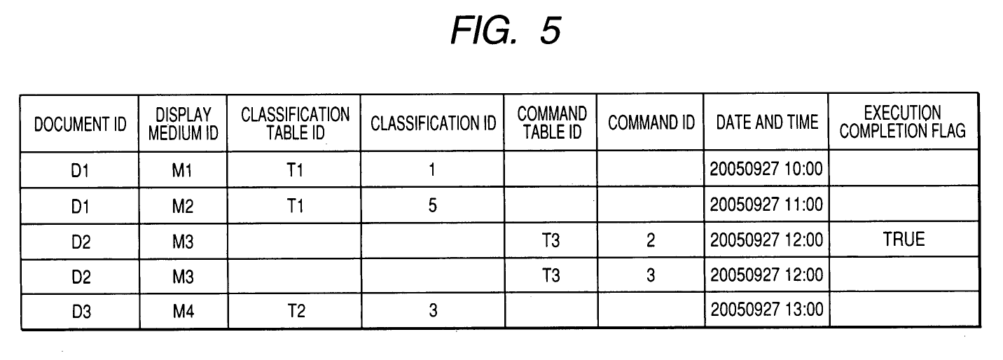

As a result of the determination processing, management information of operation information as shown in FIG. 5 (the classification ID responsive to the classification table or the command ID responsive to the command table) is retained in the determination section 34 in association with read date and time information. For example, the document with document ID (Dl) is written to two sheets of electronic paper EP with display medium IDs (M1 and M2) together with choice information of the classification table T1, choice operation information with classification ID (1) “cannot understand” is obtained from the electronic paper EP (M1), choice operation information with classification ID (5) “can well understand” is obtained from the electronic paper EP (M2), and answers relating to the document understanding degree are obtained from the users viewing the electronic paper.

The operator inputs an operation command of totalizing classification IDs with document IDs as keys or totalizing classification IDs with display medium IDs as keys to or the statistical processing section 35, which then performs statistical processing based on the determination result and displays the result of the statistical processing on the output section 36. Such statistical processing of the collected answers based on document distribution can be used as a workplace communication distribution system for enterprises, a publicity distribution system for local governments, a consumer promotion system for enterprises, an individual commodity guide system for retail stores, etc.

FIG. 11 shows the configuration of a processing unit 30 according to another exemplary embodiment of the invention.

In the exemplary embodiment, a timer in which a predetermined time is set from a setting section 37 is provided as a start operation section 39 and a trigger generated in the processing unit 30 causes a determination section 34 to start determination processing based on operation information held in a command holding section 38 and a document processing section 31 or a statistical processing section 35 to start data processing.

FIG. 12 shows the configuration of a processing unit 30 according to still another exemplary embodiment of the invention.

In the exemplary embodiment, a start operation section 39 is installed in a read unit 42 (or a write unit 41) and when the user approaches the read unit 42 for performing read processing of operation information (or when the user approaches the write unit 41 for performing write processing of a document image), a start trigger is input from the start operation section 39 for causing a determination section 34 to start determination processing based on operation information held in a command holding section 38 and a document processing section 31 or a statistical processing section 35 to start data processing.

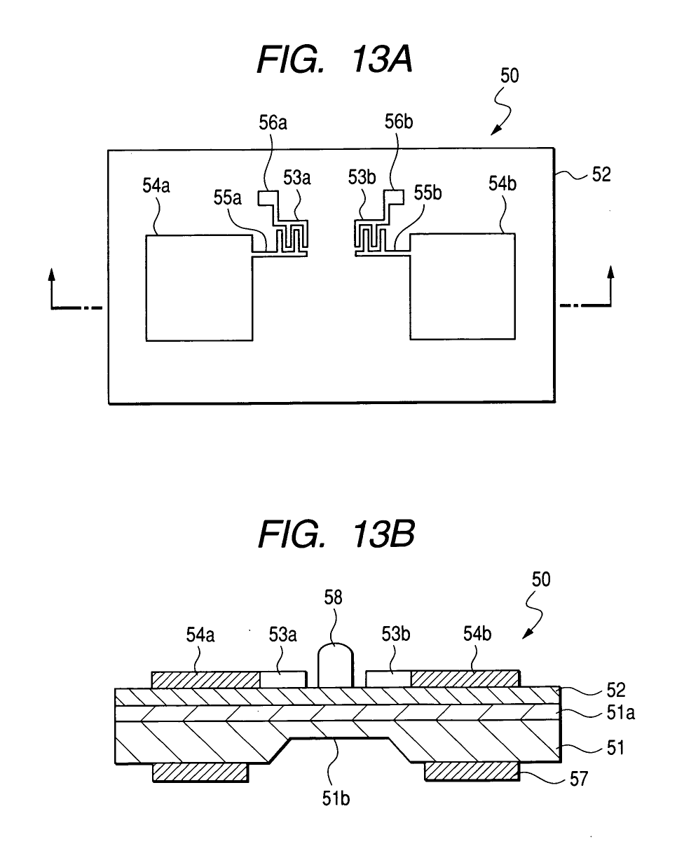

FIGS. 13A and 13B are drawings showing configurations of wireless sensor 50 relating to an exemplary embodiment of the present invention. The wireless sensor 50 has a substrate 51 made of Si base, a dielectric thin film 52 for propagating a surface acoustic wave (SAW) formed via an oxide film 51a on the substrate 51, a pair of inter-digital transducers (IDT) 53a, 53b for converting an electric signal into a surface acoustic wave or a surface acoustic wave into an electric signal formed on the dielectric thin film 52, an antenna 54a, 54b connected to one of the inter-digital transducers 53a, 53b through an impedance matching section 55a, 55b for transmitting and receiving a radio wave signal to and from an external unit (transmission-reception unit), a ground 56a, 56b connected to the other of the inter-digital transducers 53a, 53b, a ground electrode 57 formed on the back of the substrate 51 and connected to the ground 56a, 56b via a through hole (not shown) and a pressure reception section 58. The pressure reception section 58 is provided with an edge connecting to the dielectric thin film 52 and a tip a little projecting from the wireless sensor 50. By adding an external pressure to the tip of the pressure reception section 58, the dielectric thin film 52 bends, whereby the frequency of the surface acoustic wave changes. Namely, it is possible to detect a pressure made by user's finger etc.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. A document processing operation system comprising:
an image display holding medium that comprises a display section for holding display of a document image rewritably and in a substantially no-power supply state; and
a processing unit that processes document data in response to operation information of a user for the image display holding medium,
wherein the image display holding medium further comprises:
an operation device that accepts operation input from a user; and
an information providing section that provides operation information entered on the operation device to the processing unit,
wherein the processing unit comprises:
a data processing section that performs processing preset in response to the operation information for data of a document whose display is held on the image display holding medium;
a holding section that holds the operation information acquired from the image display holding medium; and
a start command section that causes the data processing section to start processing in response to the held operation information.

2. The document processing operation system according to claim 1,
wherein the start command section inputs a trigger generated in the processing unit for causing the data processing section to start processing.

3. The document processing operation system according to claim 1,
wherein the start command section inputs a trigger for causing the data processing section to start processing in response to user operation.

4. The document processing operation system according to claim 1,
wherein the processing unit has a correspondence table presetting image processing methods to display on the display section of the image display holding medium in response to the operation information, and
wherein the data processing section references the correspondence table and performs generation processing of a document image to be displayed on the display section in response to the acquired operation information.

5. The document processing operation system according to claim 1,
wherein the processing unit has a correspondence table presetting image processing methods for data corresponding to a document displayed on the display section of the image display holding medium in response to the operation information, and
wherein the data processing section references the correspondence table and performs processing for the data corresponding to the document in response to the acquired operation information.

6. The document processing operation system according to claim 1,
wherein the processing unit has a correspondence table presetting answers from users in response to the operation information, and
wherein the data processing section references the correspondence table and performs statistical processing of user answers to a document displayed on the display section in response to the acquired operation information.

7. The document processing operation system according to claim 1,
wherein the image display holding medium comprises:
a plurality of passive sensors, and each of the plurality of passive sensors has a function of detecting user operation and a function of holding a detection state in a wirelessly readable manner; and
a plurality of operation devices that accept operation input from a user by the plurality of passive sensors; and
an information providing section that provides operation information indicating which operation device operation input is executed for in a wirelessly readable manner to the processing unit.

8. The document processing operation system according to claim 1,
wherein the image display holding medium comprises:
a plurality of passive sensors, and each of the plurality of passive sensors has a function of detecting user operation and a function of transmitting a detection state in a wirelessly readable manner;
a plurality of operation devices that accept operation input from a user by the plurality of passive sensors; and
an information providing section that transmits operation information indicating which operation device operation input is executed for in a wirelessly readable manner in response to a read signal from the processing unit.

9. The document processing operation system according to claim 1,
wherein the image display holding medium is a self-write type electronic paper having a function of writing an image to the display section based on display image data input from a write section.

10. The document processing operation system according to claim 1,
wherein the image display holding medium is an optical write type electronic paper having a function of transferring a display image projected from a write section to the display section.

11. A processing unit for processing document data in response to operation information of a user for an image display holding medium, which has a display section for holding display of a document image rewritably and in a substantially no-power supply state, the processing unit comprising:
a holding section that holds the operation information acquired from the image display holding medium;
a data processing section that performs processing preset in response to the operation information acquired from the image display holding medium for data of a document whose display is held on the image display holding medium; and
a start command section that causes the data processing section to start processing in response to the held operation information.

12. A computer readable medium storing a program causing a computer to execute a process for processing document data in response to operation information of a user for an image display holding medium, which has a display section for holding display of a document image rewritably and in a substantially no-power supply state, the process comprising:
holding operation information acquired from the image display holding medium;
performing processing preset in response to the operation information acquired from the image display holding medium for data of a document whose display is held on the image display holding medium; and
causing a data processing section to start processing in response to the held operation information.

13. A document processing operation method executed with an image display holding medium that comprises a display section for holding display of a document image rewritably and in a substantially no-power supply state and a processing unit that processes document data in response to operation information of a user for the image display holding medium, the document processing operation method comprising:
acquiring operation information entered by a user for the image display holding medium from the image display holding medium and holding the operation information; and
starting processing in response to the held operation information in response to an internally generated trigger signal or an external input trigger signal.

14. A computer data signal embodied in a carrier wave for enabling a computer to perform a process for processing document data in response to operation information of a user for an image display holding medium, which has a display section for holding display of a document image rewritably and in a substantially no-power supply state, the process comprising:
holding operation information acquired from the image display holding medium;
performing processing preset in response to the operation information acquired from the image display holding medium for data of a document whose display is held on the image display holding medium; and
causing a data processing section to start processing in response to the held operation information.
